(19) United States
(12) Patent Application Publication
(10) Pub. No.: US 2007/0254675 A1
(43) Pub. Date: Nov. 1, 2007

(54) METHOD AND APPARATUS FOR DISTRIBUTED CALL ADMISSION CONTROL IN A WIRELESS NETWORK

(75) Inventors: Sebnem Zorlu Ozer, Altamonte Springs, FL (US); Guenael T. Strutt, Sanford, FL (US); Surong Zeng, Altamonte Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/380,860

(22) Filed: Apr. 28, 2006

(51) Int. Cl. H04Q 7/20

(52) U.S. Cl. 455/456.2

(57) ABSTRACT

A method for distributed call admission control in a wireless network includes the steps of: initiating a communication call within the wireless network; computing a resource metric at each of a plurality of nodes along a communication route of the wireless network, wherein each of the resource metrics is representative of a network dynamic; distributing the resource metrics along a communication route to at least one call admission control point within the wireless network; and performing a call admission process for the communication call at the at least one call admission control point using the resource metrics.

### FIELD OF THE INVENTION

The present invention relates generally to wireless networks and more particularly to distributed call admission control (CAC) in wireless networks.

### BACKGROUND

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based one-hop wireless networks, such as cellular networks or satellite networks, mesh networks are self-forming networks which can also operate in the absence of any fixed infrastructure, and in some cases the ad hoc network is formed entirely of mobile nodes. A mesh network typically includes a number of geographically-distributed, fixed and mobile units, sometimes referred to as “nodes,” which are wirelessly connected to each other by one or more links (e.g., radio frequency communication channels). The nodes can communicate with each other over a wireless media with or without the support of an infrastructure-based or wired network. Links or connections between these nodes can change dynamically in an unpredictable manner as existing nodes move within the ad hoc network, as new nodes join or enter the ad hoc network, or as existing nodes leave or exit the mesh network.

The lack of a central controller in a mesh network creates a need for new methods to provide efficient end-to-end traffic control such as call admission control (CAC). Call admission control regulates communication quality by limiting the number of calls that can be active on a particular link at the same time. Call admission control does not guarantee a particular level of quality on the link in a mesh network, but it does allow for the regulation of the amount of bandwidth consumed by active calls on the link.

Furthermore, network dynamics due to wireless channel characteristics and mobility impose additional challenges in the evaluation of network resources available to meet QoS (Quality of Service) requirements in mesh networks. Existing CAC schemes are efficient only for one-hop wireless communications or based on heavy traffic assumptions.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example communication network employing a system and method in accordance with an embodiment of the present invention.

FIG. 2 is a block diagram illustrating an example of a communication device employed in the communication network shown in FIG. 1 in accordance with an embodiment of the present invention.

FIG. 3 is a block diagram illustrating an exemplary network for which some embodiments of the present invention can be implemented

FIG. 4 illustrates an exemplary route table stored within a node of the exemplary network of FIG. 3 in accordance with some embodiments of the present invention.

FIG. 5 illustrates an exemplary neighbor table stored within a node of the exemplary network of FIG. 3 in accordance with some embodiments of the present invention.

FIG. 6 illustrates an exemplary proxy table stored within a node of the exemplary network of FIG. 3 in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to distributed call admission control in a wireless network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of distributed call admission control in a wireless network described herein. The non-processor circuits may include, but are not limited to, a radio receiver, a radio transmitter, signal drivers, clock circuits, power source circuits, and user input devices. As such, these functions may be interpreted as steps of a method to perform distributed call admission control in a wireless network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Existing call admission control methods for wireless networks are optimized for one-hop networks or based on heavy traffic assumptions, and thus do not provide efficient solutions for wireless multi-hop mesh networks due to the cross-layer optimization mechanisms utilized. For multi-hop networks, the evaluation of available network resources should not only take into account the network dynamics in terms of wireless channel characteristics and mobility but also the additional dynamics introduced by routing and MAC (Medium Access Control) algorithms in response to network changes.

Issues with multihop wireless networks include: estimating available resources in a shared medium with multihopping, differentiating network dynamics (mobility/channel characteristics vs. dynamics introduced by MAC/routing protocols), estimating measurement/prediction errors for untried or low-traffic routes, tracking changes in available resources, estimating the impact of admitted call in joint areas (in the same contention zone), exploiting cross-layer optimization, and providing a general lower-layer protocol-agnostic design with adequate controls to perform cross-layer optimization.

The QoS provision for traffic flows with strict requirements requires efficient call admission control. Providing a mechanism for wireless mesh networks with voice over internet protocol (VoIP)/video calls to find the routes with a good estimation of available resources that exhibit low variance over time would be beneficial. The mixed traffic systems need a method to find the nodes with available resources suitable for the corresponding traffic. (e.g. real-time traffic prefers low resources variance while non-real time traffic may be directed to nodes with high resources variance).

The present invention provides a novel “metric” that can be computed at each node of an ad hoc network to estimate the available resources and to distribute this metric or a combination of metrics along a route to the call admission control points. The metric is computed by measuring and estimating the dynamics introduced by topology changes and protocol behavior. The second order statistics of the metrics are also computed to estimate the confidence intervals and levels of the estimations. Furthermore, the differentiation of confidence level estimation at different sample sizes is taken into account to include appropriate error margin. The impact of new traffic on the shared medium is also taken into account.

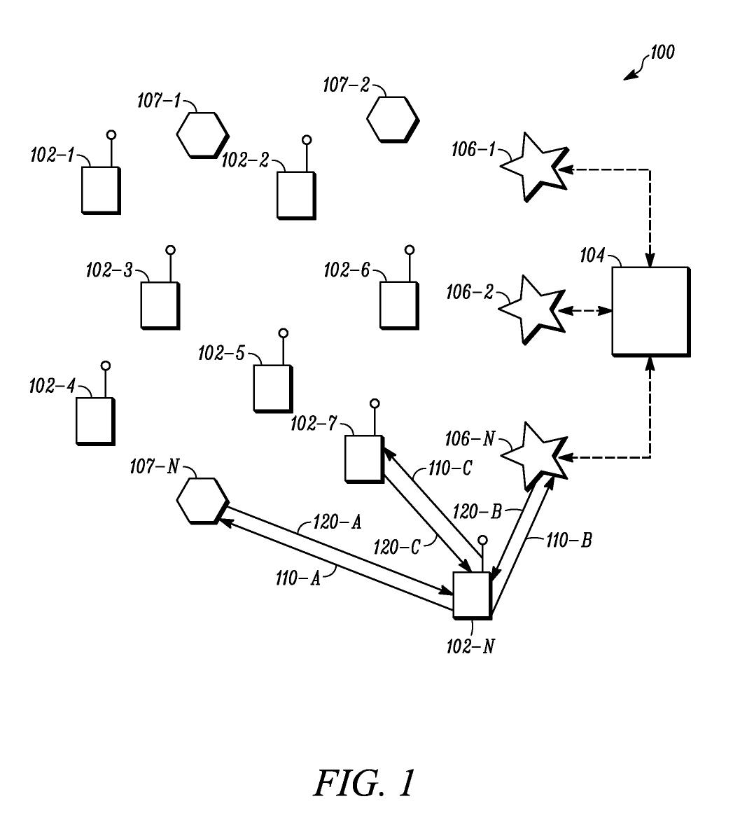

FIG. 1 is a block diagram illustrating an example of a communication network 100 employing some embodiments of the present invention. For illustration purposes, the communication network 100 comprises an adhoc wireless communications network. For example, the adhoc wireless communications network can be a mesh enabled architecture (MEA) network or an 802.11 network (i.e. 802.11a, 802.11b, or 802.1 g) It will be appreciated by those of ordinary skill in the art that the communication network 100 in accordance with the present invention can alternatively comprise any packetized communication network. For example, the communication network 100 can be a network utilizing packet data protocols such as TDMA (time division multiple access), GPRS (General Packet Radio Service) and EGPRS (Enhanced GPRS).

As illustrated in FIG. 1, the communication network 100 includes a plurality of mobile nodes 102-1 through 102-n (referred to generally as nodes 102 or mobile nodes 102 or mobile communication devices 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The communication network 100 further can include a plurality of fixed routers 107-1 through 107-n (referred to generally as nodes 107 or fixed routers 107 or fixed communication devices 107) for routing data packets between other nodes 102, 106 or 107. It is noted that for purposes of this discussion, the nodes discussed above can be collectively referred to as “nodes 102, 106 and 107”, or simply “nodes” or alternatively as “communication devices.”

As can be appreciated by one skilled in the art, the nodes 102, 106 and 107 are capable of communicating with each other directly, or via one or more other nodes 102, 106 or 107 operating as a router or routers for packets being sent between nodes. As illustrated in FIG. 1, each node communicates with other neighboring nodes using a transmitting link and a receiving link associated with the node and each of the neighboring nodes. For example, node 102-N, as illustrated, communicates with node 107-N using a transmitting link 110-A and a receiving link 120-A, communicates with node 106-N using a transmitting link 110-B and a receiving link 120-B, and communicates with node 102-7 using a transmitting link 110-C and a receiving link 120-C.

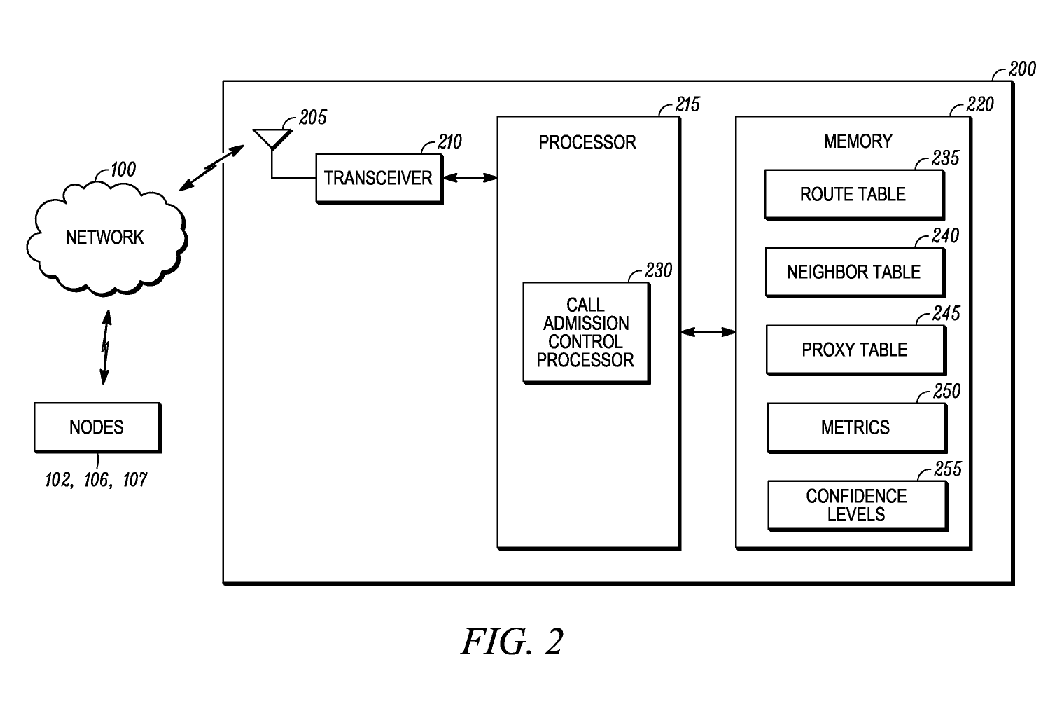

FIG. 2 is an electronic block diagram of one embodiment of a communication device 200 in accordance with the present invention. The communication device 200, for example, can exemplify one or more of the nodes 102, 106, and 107 of FIG. 1. As illustrated, the communication device 200 includes an antenna 205, a transceiver (or modem) 210, a processor 215, and a memory 220.

The antenna 205 intercepts transmitted signals from one or more nodes 102, 106, 107 within the communication network 100 and transmits signals to the one or more nodes 102, 106, 107 within the communication network 100. The antenna 205 is coupled to the transceiver 210, which employs conventional demodulation techniques for receiving and transmitting communication signals, such as packetized signals, to and from the communication device 200 under the control of the processor 215. The packetized data signals can include, for example, voice, data or multimedia information, and packetized control signals, including node update information. When the transceiver 210 receives a command from the processor 215, the transceiver 210 sends a signal via the antenna 205 to one or more devices within the communication network 100. In an alternative embodiment (not shown), the communication device 200 includes a receive antenna and a receiver for receiving signals from the communication network 100 and a transmit antenna and a transmitter for transmitting signals to the communication network 100. It will be appreciated by one of ordinary skill in the art that other similar electronic block diagrams of the same or alternate type can be utilized for the communication device 200.

Coupled to the transceiver 210, is the processor 215 utilizing conventional signal-processing techniques for processing received messages. It will be appreciated by one of ordinary skill in the art that additional processors can be utilized as required to handle the processing requirements of the processor 215.

In accordance with the present invention, the processor 215 includes a call admission control processor 230 for processing a call admission control metric and determining a best path of a direct radio signal communicated with the communication device 200 within the communication network 100. It will be appreciated by those of ordinary skill in the art that the call admission control processor 230 can be hard coded or programmed into the communication device 200 during manufacturing, can be programmed over-the-air upon customer subscription, or can be a downloadable application. It will be appreciated that other programming methods can be utilized for programming the call admission control processor 230 into the communication device 200. It will be further appreciated by one of ordinary skill in the art that the call admission control processor 230 can be hardware circuitry within the communication device 200. In accordance with the present invention, the call admission control processor 230 can be contained within the processor 215 as illustrated, or alternatively can be an individual block operatively coupled to the processor 215 (not shown). Further functionality of the call admission control processor 230, in accordance with the present invention, will be described below.

To perform the necessary functions of the communication device 200, the processor 215 is coupled to the memory 220, which preferably includes a random access memory (RAM), a read-only memory (ROM), an electrically erasable programmable read-only memory (EEPROM), and flash memory. The memory 220, in accordance with the present invention, includes storage locations for a route table 235, a neighbor table 240, and a proxy table 245. The route table 235 includes information used to determine where the node routes packets. The neighbor table 240 includes state information about adjacent neighbor nodes. When newly discovered neighbors are learned, the address and interface of the neighbor is recorded. This information is stored in the neighbor data structure. The neighbor table 240 holds these entries. The proxy table 245 includes the non-routable devices and the routable devices which proxy for those non-routable devices in the mesh networks.

In accordance with the present invention, as will be discussed in detail below, each node such as the communication device 200 further keeps track of a metric and a confidence level for all traffic (Wireless Distribution System (WDS) and Basic Service Set (BSS) based); and stores the metrics 250 and the confidence levels 255 in the memory 220.

It will be appreciated by those of ordinary skill in the art that the memory 220 can be integrated within the communication device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 200.

Estimation of Available Resources

In accordance with the present invention, an estimation of available resources is calculated periodically within the network 100 for each node. It will be appreciated by those of ordinary skill in the art that the estimation can be accomplished by a designated node, such as a call admission control point, for all nodes; or can be calculated by each node within the network as needed. For example, the estimation of available resources can be calculated by the processor 215 of the communication device 215. Further in accordance with the present invention, each estimation of available resources is based on the effective throughput and maximum throughput a node can achieve for given network conditions.

Effective throughput is computed based on the delays that a packet is subject to at every node the packet traverses (i.e. queuing, channel access and transmission delays). The delays depend on other traffic processed by the node (that is, being generated, received or forwarded by the node), other traffic in the neighborhood which shares the same medium, packet processing times, overhead introduced by the MAC and related protocols, outside interference and other channel conditions. If the sample size is large enough, the central limit theorem can be used to estimate the effective throughput. However, conditions in wireless ad hoc networks change rapidly and some routes may be idle for a long period of time and/or may not have been tried previously. This imposes a challenge on the estimation. Use of “Student t” distribution that is based on the sample size with confidence level computation helps to differentiate high variance due to limited sample size versus high dynamics in the system.

The Student t-distribution is a well-known probability distribution used for estimating the mean of a normally distributed set of values when the sample size is small (typically, less than 100 samples). Student's t-distribution arises in circumstances when the standard deviation of the data set is unknown, which is the case in wireless mesh networks that exhibit route re-configuration and MAC-level congestion.

The benefit of using the Student t-distribution is the fact that one obtains a rough estimate of the mean with a limited number of samples; and as the number of samples increases, the accuracy increases. This allows for excellent routes to be detected early (with a minimal number of samples) while poor routes may remain unfavorable even after a large set of samples has been collected. The distribution can be used to determine a lower bound or an upper bound on the data That is measured: the lower bound of the estimation would be preferably used for throughput measurement, because the throughput is better maximized in a communication network.

The maximum throughput that a node can achieve for given network conditions is computed based on the available resources in the node and in the shared medium. The available resources of a node depends on the local queue size, the traffic intended for this node that will forward it, and the rates and power levels that can be used for transmission. The channel access is based on the channel load (e.g. Clear Channel Assessment (CCA) and Network Allocation Vector (NAV) business in 802.11 networks).

The difference between the maximum throughput that a node can achieve for the current network conditions and the effective throughput measured indicates the margin to accommodate new traffic.

Defining an Efficient Metric to Estimate Available Resources:

In accordance with the present invention, a metric is defined as follows:

$$M = f ( L , {T}_{d} , {T}_{q} , {T}_{w 0} )$$

$${T}_{d} = \frac{{Nt}_{sf}}{{pcr}_{df}} + \frac{{t}_{sc} ( {pcr}_{df} + N ( 1 - {pcr}_{df} ) )}{{pcr}_{df} {pcr}_{c}} + \frac{{t}_{e} ( {pcr}_{df} ( 1 - {pcr}_{c} ) + N ( 1 - {pcr}_{df} ) )}{{pcr}_{df} {pcr}_{c}}$$

Where:

M: metric based on effective throughput (defines channel access and occupancy times)

T_{d}: average successful transmission delay

T_{q}: waiting delay

T_{wo}: initial channel access delay

P_{cr}: control and data packet completion rates

N: number of fragments

t_{sc}: successful transmission time

tₑ: penalty due to retransmissions (including shared medium busy-ness level)

It will be appreciated by those of ordinary skill in the art that new traffic on the node affects: T_{q}. It will further be appreciated by those of ordinary skill in the art that new traffic in the neighborhood affects: T_{w0} and T_{d} (tₑ), consequently T_{q}.

Best case if no other competing flow:

tₑ=f(backoff/defer time, timeout) (no channel busy-ness)

T_{w0}=f(initial backoff/defer time) (no channel busy-ness)

T_{q} is stable if arrival (accepted) traffic˜service rate

Best case if no other competing flow+perfect LQM:

tₑ=0 (with pcr's=1)

T_{w0}=f(initial backoff/defer time) (no channel busy-ness)

T_{q} is stable if arrival (accepted) traffic˜service rate

Available resources are the maximum resources the node can use (e.g. based on the operational rates provided by the link adaptation algorithm)—current usage of time (based on the effective throughput formula). It will be appreciated that Mᵢ from each precursor list must be supported by Mₒ to the next hops. Further, it will be appreciated that new traffic will affect:
M from the precursor node that sends the admission request
M to the node which is next hop for this precursor node
T_{wo} and tₑ due to the neighbor nodes

The metric of the present invention is a link quality metric which is based on resources (rate/power), packet completion rates, and overhead introduced by the MAC and other protocols.

Estimation of Traffic Load in the Shared Medium: Medium Busy-Ness
Extension of 802.11 k type measurements for multihop case may be used in 802.11 networks and traffic information in Request to Send/Clear to Send (RTS/CTS) may be used in Mea networks
Distribution of resource usage metric from neighbors (kept in the neighbor table) may be provided by using management frames

Estimation of Traffic Load in the Wireless Router
A wireless router estimates its traffic from the traffic destined towards him (distributed from the nodes in its route precursor list) and traffic in its local queue waiting to be relayed (to the next hops)
The traffic can also be estimated based on known traffic patterns, such as a particular codec used by the source

Balancing arrival and service rates at the intermediate wireless routers is accomplished by:
Resources used for reception of the traffic arriving from the nodes in the route precursor list vs. resources used for transmission of relay traffic to the nodes in the route next-hop list.
Each entry in these routing lists includes traffic and resource (LQM) information.

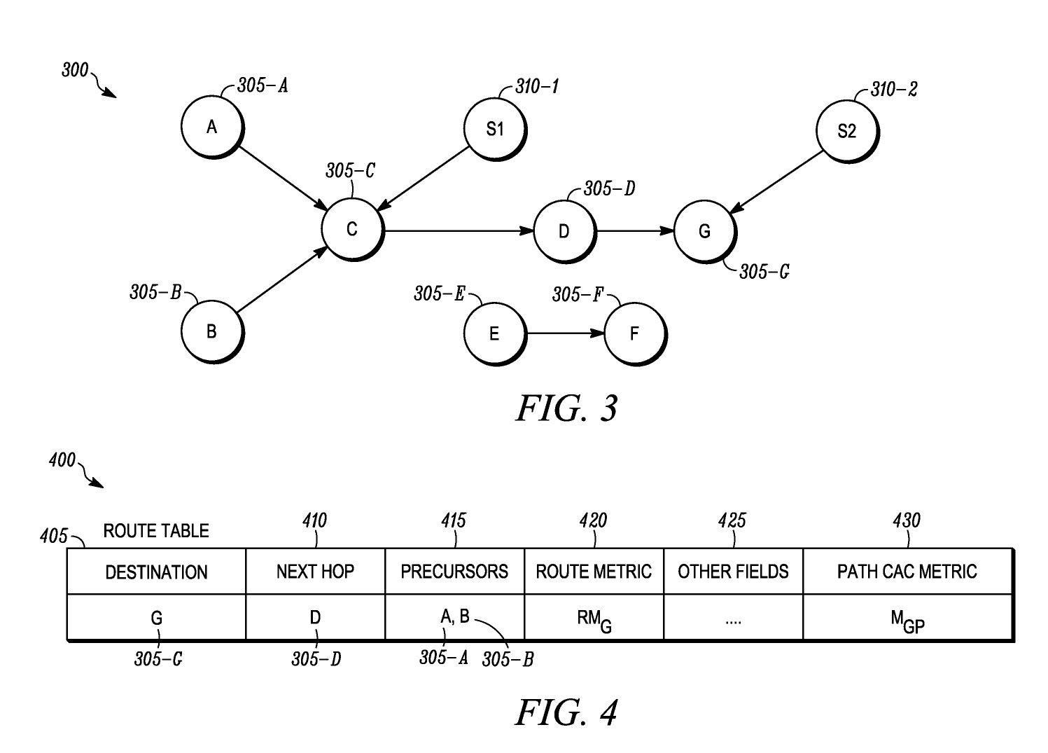

FIG. 3 illustrates an exemplary network 300 for which the present invention can be implemented. As illustrated in FIG. 3, the network 300 includes a plurality of nodes 305-N (305-A, 305-B, 305-C, 305-D, 305-E, 305-F, 305-G) and a plurality of subscriber stations 310-N (310-1, 310-2). It will be appreciated that any number and configuration of nodes 305-n and subscriber stations 310-n can be included within the network 300 in accordance with the present invention.

The present example will describe the processing at node C 305-C of data packets received from node A 305-A and B 305-B and subscriber station S1 310-1.

For reference, please note:

M_{TW}+M_{TB}=forwarding (WDS(Wireless Distribution System)+BSS (Basic Service Set)) traffic

M_{RW}+M_{RB}=incoming (WDS+BSS) traffic

M_{N}=WDS neighborhood traffic+margin

M_{S}=Self margin (for both BSS and WDS)

M_{A}=Available resources

The node C 305-C uses its resources for the incoming WDS traffic (M_{RW}) from its active precursor nodes A 305-A and B 305-B and outgoing WDS traffic (M_{TW}) to its next hop D 305-D. It also uses its resources for its BSS traffic (M_{RB}+M_{TB}) with subscriber station S1 310-1. Node C 305-C allocates a self margin (M_{S}) to tolerate fluctuations of the available resources and accommodate handoffs. Furthermore, in 802.11 type networks, node C 305-C shares the medium with its active neighbors. For the given example, node E 305-E is the neighbor of the node C 305-C and has an active flow to its next hop F 305-F. Therefore, to operate effectively, node C 305-C takes into account its neighborhood traffic (M_{N}) requirements.

The node C 305-C may measure and/or estimate its WDS and BSS traffic. M_{N} may be distributed using management frames. Since communications are half-duplex in 802.11 type networks, both traffic from precursor nodes and to the next hops are included in the M_{N} computation. However, this may cause duplicate resource usage estimation if the node is a neighbor of both the transmitter and the receiver. In this case, M_{N} may be advertised based on the link so that duplicate resource usage values can be detected. Similarly, M_{N} from the precursor and the next hop nodes are processed not to duplicate the node's WDS traffic. CCA busy-ness may be used to estimate resource usage from the nodes that are not neighbors. If multiple frequencies or radios are used, these values are per operational frequency or radio.

The node C 305-C can then compute the resource usage ratio and compute the available resources by subtracting it from its best case goodput value.

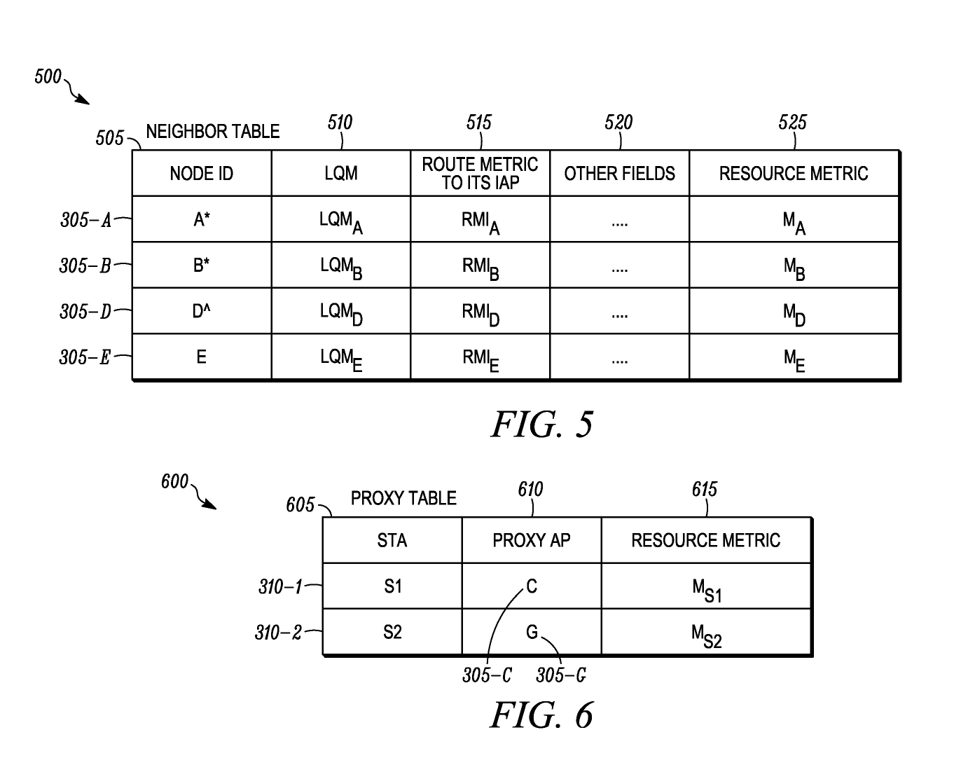

FIGS. 4 through 6 illustrate various Mesh Scalable Routing (MSR) tables at node C 305-C of the network 300. Specifically, FIG. 4 illustrates an exemplary route table 400, FIG. 5 illustrates an exemplary neighbor table 500, and FIG. 6 illustrates an exemplary proxy table 600 at node C 305-C of the network 300.

As illustrated in FIG. 4, the route table 400 includes route information such as a final destination 405, a next hop 410, one or more precursors 415, a route metric 420, one or more other fields 425, and a path CAC metric 430. For the example involving node C 305-C of FIG. 3, the final destination 405 is stored as node G 305-G, the next hop 410 is stored as node D 305-D, the precursors 415 are stored as node A 305-A and node B 305-B, the route metric is RM_{G}, and the path CAC metric 430 is stored as M_{GP}. Since nodes C 305-C, D 305-D and G 305-G may compute their available resources as described above, the path metric M_{GP}. from node C 305-C to node G 305-G may be computed by distributing this information between nodes C 305-C and G 305-G. For instance, this value may be the minimum available resources at an intermediate node on the path with a corresponding variance.

As illustrated in FIG. 5, the neighbor table 500 includes information on neighbor nodes 505 including a LQM 510, a route metric to its IAP 515, one or more other fields 520, and a resource metric 525. For the example involving node C 305-C of FIG. 3, this information is stored for each node including node A 305-A, node B 305-B, node D 305-D, and node E 305-E. As described above, this information may be distributed using management frames. The node C 305-C processes the advertised values to ensure that duplicate values are removed for the precursor and next hop nodes and for the links of which both receiver and transmitter are neighbors of node C 305-C. These values representing WDS traffic are used to update the available resources at node C 305-C.

As illustrated in FIG. 6, the proxy table 600 includes information on various subscriber stations 605 including a proxy AP 610 and a resource metric 615. For the example involving node C 305-C of FIG. 3, this information is stored for each subscriber station including station S1310-1 and station S2 310-2. These values representing BSS traffic are used to update the available resources at node C 305-C.

In accordance with the present invention, the following basic rules will be applied:
Service rate M_{TW}+M_{TB} (forwarding capacity) of an intermediate node should accommodate the incoming (accepted) traffic M_{RW}+M_{RB} at an intermediate node->differentiation of M_{A} due to different neighborhoods in 2-hop range
New traffic on the node and in the neighborhood should not degrade the QoS (i.e, can not be larger than M_{A})
Wireless link changes should not slow down/block/drop other nodes' traffic (interaction of ATP, congestion control and route changes based on LQM)
Available resources along a path are not only based on the minimum available resources at an intermediate node but also on the maximum variance.
For real-time traffic nodes with low variance in M_{A} will be selected (affected by other metrics such as M_{N}).

Measuring the Confidence Level

As mentioned previously herein, a confidence level 255 for each neighboring node is stored in the memory 220 of the communication device 200 for utilization in call admission control. Variance over time is evaluated by differentiating variance due to estimation accuracy (or measurement accuracy for a given sample size using student t distribution) versus system dynamics. Scouting packets are used to estimate the variance over time for routes that are proactively maintained to key nodes such as intelligent access points (IAPs). Using scouting packets reduces the variance of the metric estimate for routes to key nodes such as IAPs where proactive routes are maintained. Assumptions include limited sample size and small coherence time. Furthermore, Student's t-distribution (employed in circumstances where the actual standard deviation of the data is unknown) establishes an upper bound and a lower bound to the measured value (the resource metric), based on a confidence interval (which is configurable, and can be as low as 50% or as high as 99.99% or more). These methods differentiate variance due to estimation accuracy (or measurement accuracy for a given sample size using the Student t-distribution) versus system dynamics.

Distribution of the Resource Metric

In accordance with the present invention, the resource metric is distributed for new or handoff calls during the route establishment at the end points. A new management frame can be used to request this metric when a new or handoff call is initiated. Since the metric can change later, it is compared to a predetermined threshold at each node and related information is distributed at the end points if it exceeds this threshold.

For example, for the wireless mesh networks that use a contention based MAC protocols (e.g. 802.11), each traffic admitted affects not only the selected route but also joint zones, that is, zones that share the same communication medium with this route. It is difficult to estimate the impact of the new traffic on the system. This invention relies on the intermediate nodes to estimate the negative impact of the new traffic on the neighborhood. This is achieved by informing the neighbor nodes about the queue and priority status. Examples of congestion control, for example, can be found in U.S. patent application Ser. No. 11/158,737, entitled “System And Method For Rate Limiting In Multi-Hop Wirelss Ad-Hoc Networks”, filed Jun. 22, 2005; U.S. patent application Ser. No. 11/260,826, entitled “System And Method For Providing Quality Of Service (Qos) Provisions And Congestion Control In A Wireless Communication Network”, filed Oct. 27, 2005; and U.S. patent application Ser. No. 11/300,526, entitled “System And Method For Controlling Congestion In Multihopping Wireless Networks”, filed Dec. 14, 2005, each incorporated herein by reference in its entirety.

If there is a potential for negative impact on the high priority nodes, a penalty term is added into the resource metric. Therefore, a node with available resources and low priority neighbors can accept a call with a higher margin than a node with the same resources but busy high priority neighbors. A drawback of this method is that the handoff call may be at a boundary line and the candidate route nodes may think that this call is still a part of the joint zone. To avoid this problem at the boundary lines, a call that initiates a new route request may inform the neighbors along the path.

The call admission requests/replies may be incorporated in the routing messages or new management frames may be defined

Since the described call admission control mechanism requests information that can be provided by MAC feedbacks, routing messages, and QoS fields that may be available in contention-based networks, it can be applied on top of existing networks.

Changes in the available resources are tracked per route to inform end users using precursor and next hop lists in case local repair is not available.

In summary, in accordance with the present invention, every intermediate node assists in the call admission. Further, requests can be dropped (i.e. negatively acknowledged) if an intermediate node can not meet the requirements.

It will be appreciated that also in accordance with the present invention, nodes in the neighborhood assist in the call admission. For example, each node keeps track of its neighbors' advertised metric and priority levels. When a new call request comes, the node checks if the least neighbor margin can be provided. If a high priority call is allowed to preempt, the node with the lowest priority will be preempted by a “route reset.” Changes in the available resources are tracked per route to inform end users using precursor and next hop lists in case local repair is not available

Call Admission Control based on Resource Metric

In accordance with the present invention, a call admission control point accepts a new call or a handoff call based on the metrics distributed by the candidate routes. If the traffic to be admitted has strict QoS requirements then the route with the best metric in terms of mean and variance with high level confidence is preferred. For other traffic, routes with high variance and low confidence levels may be acceptable.

Another responsibility of the call admission control point is to track the changes distributed from the routes to initiate or inform other control points of the required actions, (e.g. changing routes, shaping or policing traffic, and the like).

Each route has a metric based on the mean and variance where variance is weighted based on the reason of dynamics (including sample size, trial numbers etc.). Real-time traffic selects route with minimum variance while bursty traffic may choose routes with high peak rates and high variance. Since neighbors' margin and priority levels are taken into account, a neighbor route (in the contention zone) with low variance carrying high priority traffic may block a bursty traffic in the neighborhood.

This invention enables estimation of available resources in multi-hop networks by taking into account per link usage of resources in the neighborhood. The differentiation of the causes of fluctuations in the resource estimation increases the accuracy of the proposed method and helps to choose appropriate routes based on the QoS requirements. Since CAC information is incorporated into the routing and proxy table information, cross-layer optimization between routing and resource reservation and flow control (congestion control) for half duplex radios are enabled with the same method.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for distributed call admission control in a wireless network comprising the steps of:
initiating a communication call within the wireless network;
computing a resource metric at each of a plurality of nodes along a communication route of the wireless network, wherein each of the resource metrics is representative of a network dynamic;
distributing the resource metrics along a communication route to at least one call admission control point within the wireless network; and
performing a call admission process for the communication call at the at least one call admission control point using the resource metrics.

2. A method for distributed call admission control as claimed in claim 1, wherein the network dynamic comprises one or more network dynamics introduced by one or more of a group comprising a topology change and a protocol behavior.

3. A method for distributed call admission control as claimed in claim 1, wherein the resource metric comprises a link quality metric which is based on one or more resources (rate/power), one or more packet completion rates, and one or more overheads introduced by MAC and other protocols.

4. A method for distributed call admission control as claimed in claim 1, wherein the resource metric comprises an estimate of one or more available network resources.

5. A method for distributed call admission control as claimed in claim 4, wherein
the estimation of one or more available network resources is based on an effective throughput and a maximum throughput each of the plurality of nodes can achieve for one or more given network conditions.

6. A method for distributed call admission control as claimed in claim 5, wherein the effective throughput at the node is computed using one or more delays that a packet is subject to at the node.

7. A method for distributed call admission control in a wireless network as claimed in claim 5, wherein the maximum throughput at the node is computed for a given network condition using one or more available resources in the node and in a shared medium.

8. A method for distributed call admission control in a wireless network as claimed in claim 1, wherein the distributing step comprises:
utilizing the distributed resource metrics received at an at least one neighbor node to compute an associated resource metric for the at least one neighbor node.

9. A method for distributed call admission control in a wireless network as claimed in claim 8, wherein the distributing step comprises:
distributing each of the resource metrics from the at least one neighbor node along the communication route.

10. A method for distributed call admission control as claimed in claim 1, wherein the performing the call admission process step comprises selecting a processing operation from an operation group comprising establishing the communication call, terminating the communication call, and handing off the communication call to another call admission control point.

11. A method for distributed call admission control as claimed in claim 1, further comprising the steps of:
computing a resource metric at each of a second plurality of nodes along a second communication route of the wireless network, wherein each of the resource metrics is representative of a network dynamic;
distributing the resource metrics along the second communication route to at least a second call admission control point within the wireless network;
performing a second call admission process for the communication call at the at least second call admission control point using the resource metrics; and
selecting a communication call route for the communication call using the call admission process and the second call admission process.

12. A method for distributed call admission control as claimed in claim 11, wherein the selecting step comprises selecting the communication call route having a low resource variance when the communication call comprises real time traffic.

13. A method for distributed call admission control as claimed in claim 11, wherein the selecting step comprises selecting the communication call route having a high resource variance when the communication call comprises non-real time traffic capable of tolerating the high resource variance.

14. A method for distributed call admission control as claimed in claim 1, further comprising the steps of:
computing a precision of the resource metric after the computing the resource metric step, and
wherein the precision of the resource metric is used in the performing the call admission process for the communication call step.

15. A method for distributed call admission control as claimed in claim 14, wherein the precision of the resource metric includes one or more computations selected from a group comprising a confidence interval and an estimation level.

16. A method for distributed call admission control as claimed in claim 14, wherein the computing the precision of the resource metric step comprises:
computing one or more second order statistics of the resource metric.

17. A method for distributed call admission control in a wireless network as claimed in claim 14, wherein the computing the precision of the resource metric step comprises the steps of:
estimating a confidence level associated with a plurality of sample sizes;
defining a differentiation of the confidence levels; and
determining an error margin using the differentiation of the confidence levels.

18. A method for distributed call admission control in a wireless network as claimed in claim 1, wherein the resource metric step comprises the steps of:
measuring an incoming and an outgoing traffic;
allocating a self margin to tolerate fluctuations of one or more available resources and to accommodate handoffs;
computing a resource usage ratio using the measured incoming and outgoing traffic and the self margin; and
computing the resource metric by subtracting the resource usage ratio from a goodput value of the node.

19. A method for distributed call admission control in a wireless network as claimed in claim 18, wherein the computing the resource metric step further comprises prior to the measuring step, the steps of:
using a first portion of node resources for one or more incoming traffic from one or more active precursor nodes;
using a second portion of node resources for one or more outgoing traffic to a next hop node; and
using a third portion of node resources for one or more traffic with one or more subscriber stations.

20. A method for distributed call admission control in a wireless network as claimed in claim 1, wherein the wireless network is an 802.11 network, the method further comprising the steps of:
sharing a communication medium by the node with one or more active neighbor nodes; and
determining a neighborhood traffic requirement of the one or more active neighbors nodes, and
wherein the computing the resource metric step utilizes the neighborhood traffic requirement.
